(19) United States
(12) Patent Application Publication
(10) Pub. No.: US 2014/0183847 A1
(43) Pub. Date: Jul. 3, 2014

(54) VEHICLE WITH AN INSTRUMENT PANEL

(71) Applicant: GM Global Technology Operations LLC, Detroit, MI (US)

(72) Inventors: Ulrich RICK, Braunweiler (DE); Christoph DAAB, Darmstadt (DE); Frank SATERDAG, Kelsterbach (DE)

(73) Assignee: GM Global Technology Operations LLC, Detroit, MI (US)

(21) Appl. No.: 14/095,206

(22) Filed: Dec. 3, 2013

(30) Foreign Application Priority Data
Dec. 4, 2012 (DE) 10 2012 023 666.2

(51) Int. Cl. B60R 21/205

(52) U.S. Cl. CPC B60R 21/205
USPC 280/730.1

(57) ABSTRACT

An instrument panel is integrated into the vehicle, and extends from the driver to the passenger side in a longitudinal extension. The vehicle encompasses a steering wheel, which is arranged on the driver side, and protrudes from the instrument panel in a direction oriented opposite the traveling direction of the vehicle. The vehicle exhibits an airbag module with at least one airbag, which is integrated into the instrument panel in front of the steering wheel as viewed in the traveling direction. The airbag is designed to inflate when and/or after activated out of an opening arranged in the instrument panel in an inflating direction oriented in the direction of an upper body position of the driver. The instrument panel encompasses a guiding ramp, which is designed to guide the airbag over the steering wheel as it being inflated in the inflating direction.

### CROSS-REFERENCE TO RELATED APPLICATION

This application claims priority to German Patent Application No. 10 2012 023 666.2, filed Dec. 4, 2012, which is incorporated herein by reference in its entirety.

### TECHNICAL FIELD

The technical field relates to a vehicle with a driver and passenger side and an instrument panel, which is integrated into the vehicle and extends from the driver side to the passenger side in a longitudinal extension.

### BACKGROUND

Airbag modules are often integrated into vehicle instrument panels. The airbag modules encompass at least one airbag. This airbag protects a vehicle occupant during a collision by inflating in the direction of the occupant.

Publication DE 10 23 51 28 A1 discloses an airbag device with at least two airbags, which are designed to in tandem brace at least two vehicle occupants in a vehicle in the event of an accident. The gasbags are folded into a shared housing to be arranged in the dashboard of the motor vehicle.

In view of the foregoing, at least one object is to provide a vehicle with a functionally improved instrument panel. In addition, other objects, desirable features and characteristics will become apparent from the subsequent summary and detailed description, and the appended claims, taken in conjunction with the accompanying drawings and this background.

### SUMMARY

A vehicle with a driver and passenger side and with an instrument panel is proposed. The instrument panel is integrated into the vehicle, and extends from the driver to the passenger side in its longitudinal extension. The instrument panel can extend over the entire width of a vehicle interior. Alternatively, it is possible for the latter to only extend over a partial segment of the interior width. The instrument panel exhibits an upper side oriented toward a vehicle windshield. It optionally also encompasses a front side, which is oriented in a direction opposite the traveling direction of the vehicle.

The vehicle encompasses a steering wheel, which is arranged on the driver side, and protrudes from the instrument panel in a direction oriented opposite the traveling direction of the vehicle. In particular, the driver side provides space for a driver, who can usually sit down in a driver seat behind the steering wheel in the traveling direction. The passenger side preferably provides space for a passenger, wherein the passenger sits next to the driver on a passenger seat.

The vehicle exhibits an airbag module with at least one airbag. The airbag module is integrated into the instrument panel in front of the steering wheel as viewed in the traveling direction. The airbag module is preferably integrated centrally relative to the longitudinal extension of the instrument panel between the driver and passenger side into the upper side of the instrument panel.

The at least one airbag is designed to inflate when and/or after activated, for example as the result of a vehicle collision, out of an opening arranged in the instrument panel in an inflating direction. In particular, the inflating direction is oriented toward the upper body position of the driver. The upper body position optionally encompasses a position of the rib cage and head of the driver. In the inflated state, the at least one airbag is preferably designed to catch the driver during a collision of the vehicle, prevent an impact with the steering wheel, and thereby protect him or her against injuries.

The instrument panel encompasses a guiding ramp, which is designed to guide the airbag over the steering wheel or past the steering wheel as it is being inflated in the inflating direction. Due to the guiding ramp and the fact that it guides the airbag over the steering wheel or past the steering wheel, the airbag can advantageously exert its protective effect on the driver in a complete and reliable manner. In particular, the airbag can be prevented from becoming snagged on the steering wheel and/or directionally diverted by the steering wheel. In particular, the guiding ramp ensures that the airbag is not impeded by the steering wheel as it inflates. This makes it possible to largely avoid injuries to the driver given a collision of the vehicle.

In an embodiment, the guiding ramp bridges a gap between the instrument panel and steering wheel in the direction oriented opposite the traveling direction. In particular, the guiding ramp protrudes from the instrument panel as an upwardly inclined canopy oriented in a direction opposite the traveling direction. For example, the guiding ramp closes the gap between the instrument panel and steering wheel by at least approximately 45%, preferably at least approximately 55%, especially at least approximately 65%.

In an embodiment, an imaginary extension of the guiding ramp, in particular an upper side of the guiding ramp, runs over the steering wheel in the inflating direction of the airbag. In particular the guiding ramp, especially the upper side of the guiding ramp, does not intersect the steering wheel in the imaginary extension and in the inflating direction. Specifically, the guiding ramp, in particular the upper side of the guiding ramp, runs past the steering wheel, in particular the steering wheel rim, in the extension and in the inflating direction. As a result, the airbag is not snagged by the steering wheel or impeded by the latter while inflating.

In one embodiment, the guiding ramp protrudes from the instrument panel in the direction oriented opposite the traveling direction or at an angle relative thereto. In particular, the guiding ramp is adjusted or identical to the inflating direction of the airbag in the direction and/or progression in which it protrudes from the instrument panel. As a result, the airbag slides along the guiding ramp while inflating, and is guided in the correct direction, in particular the inflating direction.

The guiding ramp is arranged between the opening in the instrument panel and the steering wheel in the longitudinal extension of the instrument panel. The guiding ramp, in particular in an end region of the guiding ramp oriented toward the opening, exhibit a width in the longitudinal extension of the instrument panel that corresponds to a width of the opening or is adjusted thereto. It is also possible for the width of the guiding ramp to go beyond the width of the opening.

In an embodiment, the guiding ramp is arranged centrally or roughly centrally relative to the longitudinal extension of the instrument panel between the driver and passenger side. In particular, the guiding ramp is arranged above a central console of the vehicle. It is possible for functional elements to be integrated or integratable into the instrument panel in the longitudinal extension of the instrument panel, centrally between the driver and passenger side, in particular in the extension of the central console in the traveling direction. For example, the functional elements of the vehicle can take the form of displays, operator controls, heaters and/or ventilators, audio, sound and/or communication devices and/or electronic interfaces and/or controllers. Alternatively or optionally, the functional elements of the vehicle can be enhanced to encompass storage compartments.

The airbag module between the driver and passenger side is integrated into the instrument panel centrally to its longitudinal extension. In one embodiment, the airbag is a central airbag for simultaneously protecting several individuals, in particular the driver and passenger. In particular, when and/or after activated as the result of a vehicle collision, the airbag inflates in the direction of the upper body and/or head position of the driver and passenger, so as to protect the latter against injuries. While the airbag can optionally inflate unimpeded in the direction of the upper body and head position of the passenger, the steering wheel presents or can present an interfering contour and/or obstacle as the airbag inflates toward the upper body and head position of the driver. The guiding ramp is designed in particular to guide the airbag as it inflates in such a way as to circumvent or not be impeded by the interfering contour and/or obstacle.

The guiding ramp forms a first hood section for the functional elements. The first hood section shields the functional elements away from exposure to sunlight shining through a windshield vehicle. The first hood section is optionally designed as a separate, independent and/or standalone hood.

In embodiment, the guiding ramp passes over to an upper side of the instrument panel oriented toward the windshield of the vehicle. Alternatively or optionally, the guiding ramp additionally at least partially and/or sectionally forms the upper side.

A cross section of the guiding ramp perpendicular to or an inflating direction of the airbag optionally exhibits a trough-like recess. The trough-like recess is preferably designed to stabilize the inflating airbag and/or point it in the correct direction, in particular in the direction of the driver. Specifically, the trough-like recess prevents the airbag from sagging as it inflates in the inflating direction. In particular, it helps the airbag to exert its protective effect on the driver in an advantageous manner.

In an embodiment, the instrument panel encompasses a second hood section for instrument displays arranged on the driver side and in the instrument panel in front of the steering wheel as viewed in the traveling direction. For example, the instrument displays are designed as a speedometer and fuel gauge for the vehicle. The second hood section is designed to protect the instrument displays against exposure to sunlight shining through the windshield of the vehicle, and prevent the driver from being blinded while reading the displays.

The first hood section and second hood section be joined together as a single piece and/or consist of a single material. It is especially preferred that the first and second hood section be integrally joined together. In particular, the first and second hood sections form a common hood. The first and second hood sections extend as the common hood from the driver side to a center of the instrument panel. It is also possible for the common hood to extend from the driver side beyond the center of the instrument panel, in particular in the direction of the passenger side. It is preferred that the common hood extend over at least approximately 35%, preferably at least approximately 45%, in particular at least approximately 55% of the longitudinal extension of the instrument panel.

The common hood extends at least partially or sectionally along the longitudinal extension of the instrument panel in a wavelike fashion. At least one wave section of the common hood preferably forms the guiding ramp. In particular, an additional wave section of the common hood forms the second hood section.

### BRIEF DESCRIPTION OF THE DRAWINGS

The present invention will hereinafter be described in conjunction with the following drawing figures, wherein like numerals denote like elements, and:

FIG. 1 is a schematic, perspective top view of a vehicle with an instrument panel;

FIG. 2 is a front view of the instrument panel from FIG. 1;

FIG. 3 is a top view from above of the instrument panel from FIG. 1 and FIG. 2;

FIG. 4 is a perspective view of the instrument panel from FIG. 1 to FIG. 3;

FIG. 5 is a top view from above of an alternative instrument panel to the one from FIG. 3; and

FIG. 6 is a section through FIG. 3 or FIG. 5 along the A-A line.

### DETAILED DESCRIPTION

The following detailed description is merely exemplary in nature and is not intended to limit application and uses. Furthermore, there is no intention to be bound by any theory presented in the preceding background or summary or the following detailed description.

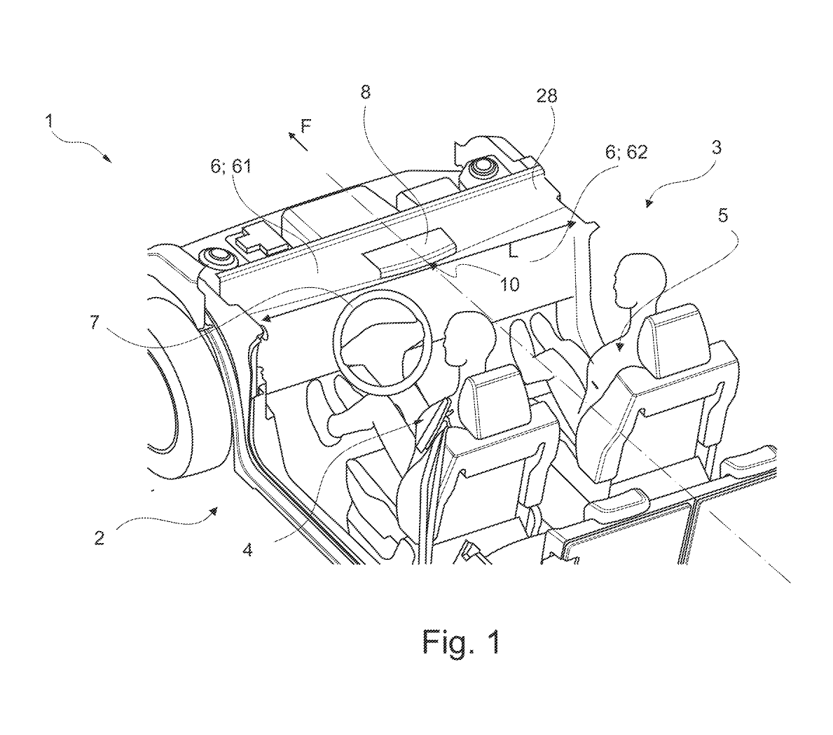

FIG. 1 shows a perspective, top view of a vehicle 1 as an embodiment. The vehicle 1 exhibits a driver side 2 and passenger side 3. A driver 4 sits on the driver seat on the driver side 2, while a passenger 5 sits on the passenger seat on the passenger side 3.

The vehicle 1 encompasses an instrument panel 6, which in its longitudinal extension L extends from the driver side 2 to the passenger side 3. The instrument panel 6 exhibits an upper side 61 and a front side 62. The upper side 61 is oriented toward a windshield of the vehicle (not shown), while the front side 62 is oriented opposite a traveling direction F of the vehicle 1 toward the driver 4 and passenger 5.

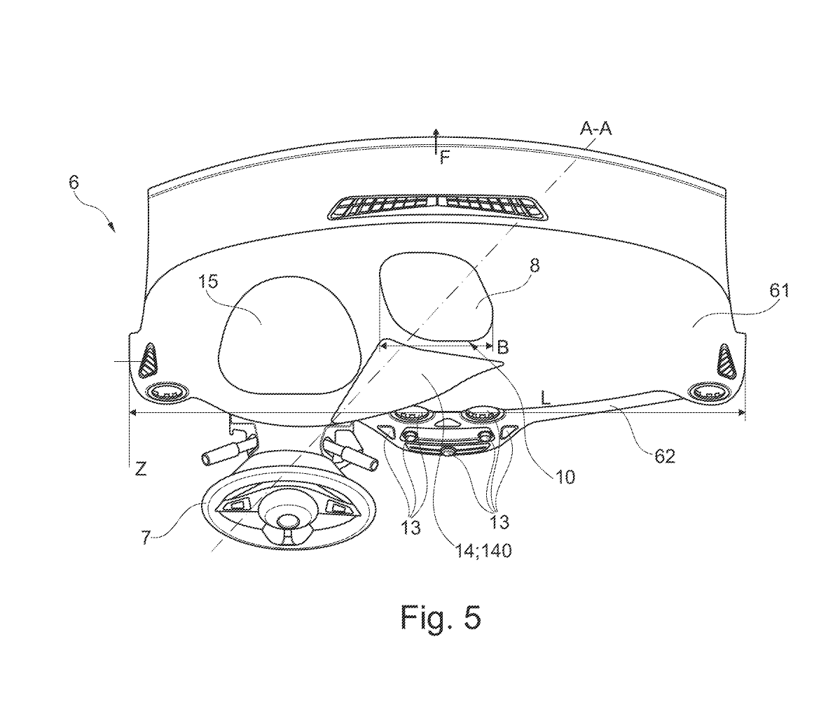

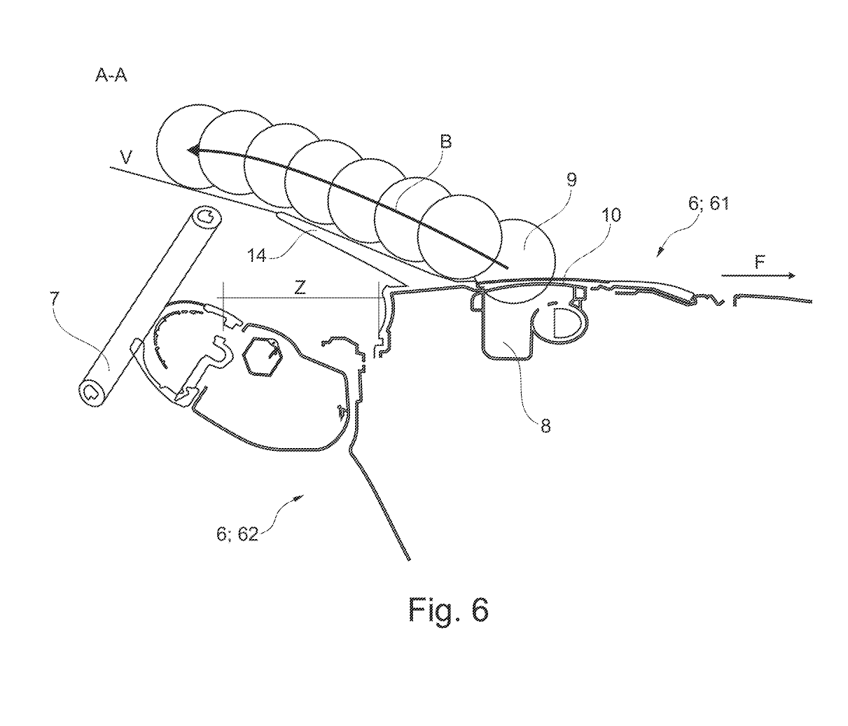

The vehicle 1 exhibits a steering wheel 7 and an airbag module 8 with an airbag 9 (FIG. 5). The steering wheel 7 is arranged on the driver side 2 on the instrument panel 6, and protrudes from the latter in a direction oriented opposite the traveling direction F. The airbag module 8 is integrated between the driver and passenger side 2; 3 and centrally in the instrument panel 6 in the longitudinal extension L. The instrument panel 6 exhibits an opening 10, through which the airbag 9 (FIG. 5) inflates out of the airbag module in an inflating direction B when and/or after activated, e.g., by a collision of the vehicle 1 (FIG. 6). In the inflated state, the airbag 9 is designed to protect the driver 4 and optionally also the passenger 5 against injuries during a vehicle collision.

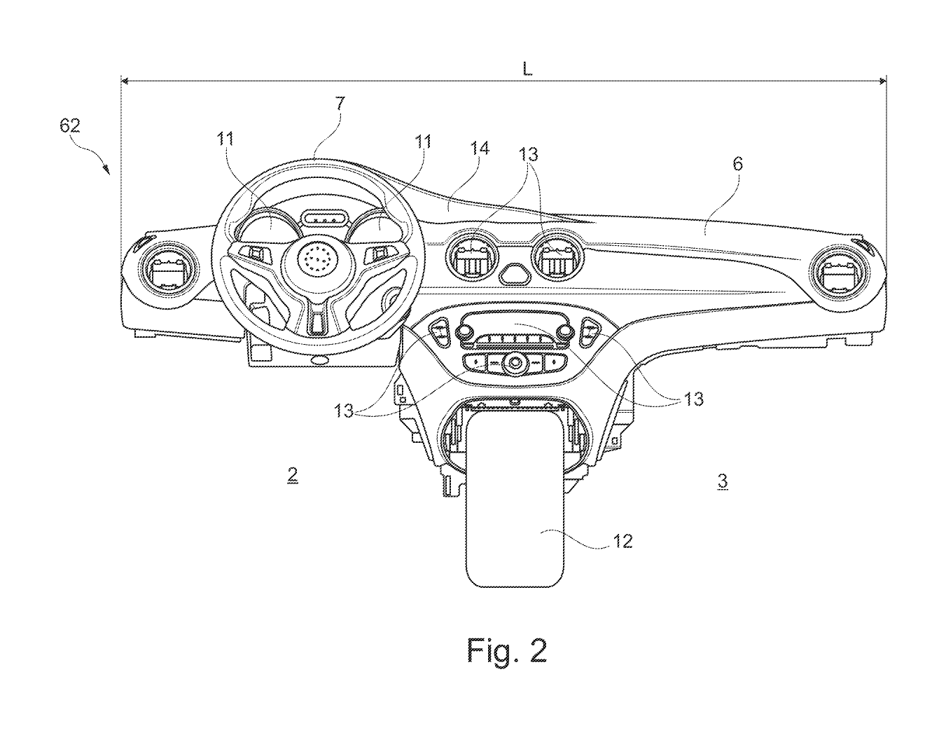

FIG. 2 shows a view of the front side 62 of the instrument panel 6. Several instrument displays 11, e.g., displays indicating the speed, consumption or fuel level of the vehicle 1, are arranged on the driver side 2 and in front of the steering wheel 7 in the traveling direction. Several functional elements 13 are arranged in the center of the instrument panel 6 and in the extension of a center console 12 of the vehicle 1. The functional elements 13 consist of vent holes, control knobs, interfaces and/or control elements, as well as of audio or sound elements.

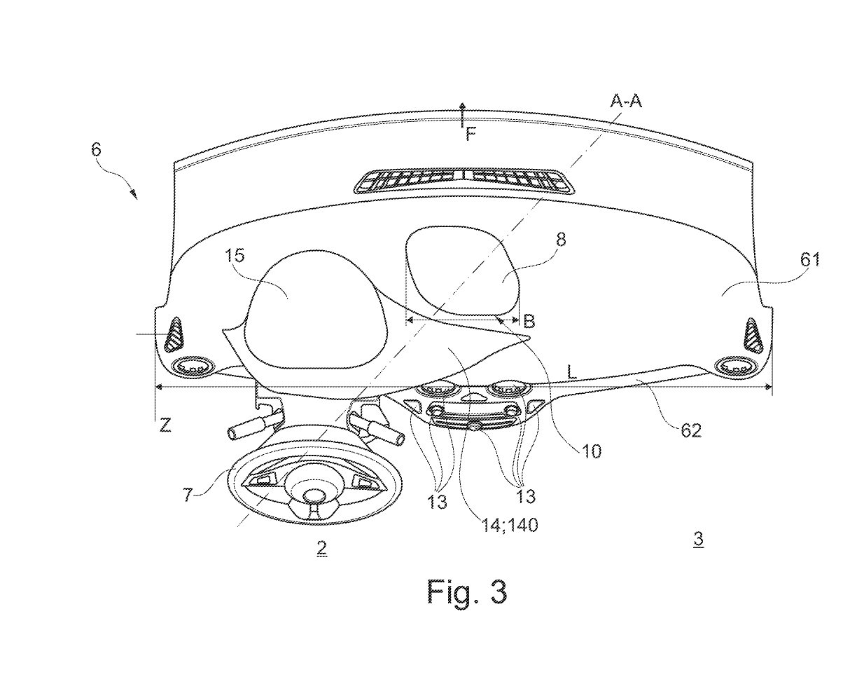

The instrument panel 6 encompasses a guiding ramp 14, which is designed to guide the airbag 9 (FIG. 6) over the steering wheel while being inflated in the inflating direction B. The guiding ramp 14 is arranged centrally between the driver and passenger side 2; 3 in the longitudinal extension L of the instrument panel 6. The guiding ramp 14 passes over to the upper side 61 (FIG. 1, FIG. 3) of the instrument panel 6 and/or at least sectionally forms the latter.

According to FIG. 3, which shows a top view of the upper side 61 of the instrument panel 6, the guiding ramp 14 protrudes from the instrument panel 6, in particular from its front side 62, in the direction oriented opposite the traveling direction F. It partially bridges a gap Z between the steering wheel 7 and instrument panel 6, in particular its front side 62. The guiding ramp 14 is arranged in the longitudinal extension L of the instrument panel 6 between the opening 10 and steering wheel 7. It exhibits a width going beyond the width B of the opening.

The guiding ramp 14 comprises a first hood section 140 for the functional elements 13, which are centrally integrated into the instrument panel 6. The first hood section 140 is designed to protect the functional elements 13 against exposure to sunlight that may shine through the windshield and into the vehicle 1. As an alternative or optional enhancement, the first hood section 140 is a design element intended to create an optically appealing midsection of the instrument panel 6 in the vehicle 1. In particular from a functional and optical standpoint, the functional elements 13 are arranged and/or bundled under the first hood section 140.

The instrument panel 6 exhibits a second hood section 15. The latter is arranged on the driver side 2 in front of the steering wheel 7 as viewed in the traveling direction F of the vehicle 1, and protects the instrument displays 11 against exposure to sunlight, thereby ensuring a good legibility for the driver 4. The first hood section 140 and second hood section 15 are joined together as a single piece, and designed as an integral component. The first and second hood sections 140; 15 are made out of the same material in the same manufacturing step. They together form a common hood 16. In a top view from above, the common hood 16 exhibits an outer contour that mirrors or resembles the shape of a drop or wing.

In the integral connection between the first and second hood section 140; 15, the first hood section 15 is lengthened in the direction toward the steering wheel 7 oriented opposite the traveling direction, and covers roughly half of the gap Z between the front side 62 of the instrument panel 6 and the steering wheel 7. The common hood 16 extends from the driver side 2 up to the center of the instrument panel 6 arranged between the driver and passenger side 2; 3. It here extends over at least approximately 45%, in particular at least approximately 55% of the longitudinal extension L of the instrument panel 6.

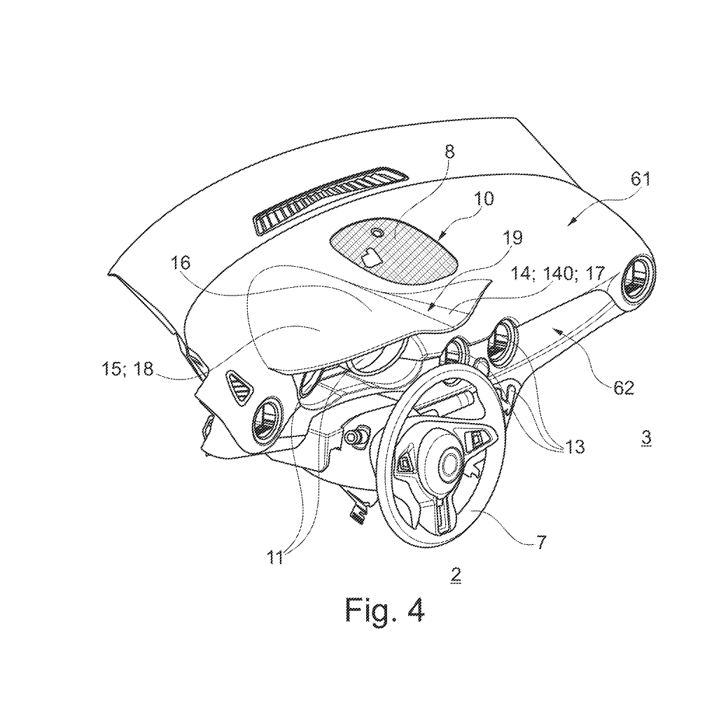

According to FIG. 4, which shows a perspective view of the instrument panel 6, the common hood 16 extends wavelike along the longitudinal extension L of the instrument panel 6, in particular from the driver side 2 up to the center of the instrument panel 6. A first wave section 17 forms the first hood section 140 for the functional elements 13, while a second wave section 18 forms the second hood section 15 for the instrument displays 11.

The guiding ramp 14 or first hood section 140 exhibits a trough-like recess 19. This stems in particular from the wavelike configuration of the common hood 16. The trough-like recess 19 and the back of the wave ascending in the direction of the second wave section 18 create a firing ramp for the airbag 9. The guiding ramp 14 is designed to stabilize the airbag 9 (FIG. 6) while it inflates, and to guide it in the correct direction, in particular in the direction of the upper body and head of the driver 4. The guiding ramp 14 and trough-like recess 19 ensure that the airbag 9 can be guided over the steering wheel 7, and exert its full protective effect on the driver 4 (FIG. 1). In particular, the guiding ramp 14 prevents the airbag 9 from being snagged by the steering wheel 7.

FIG. 5 shows an alternative instrument panel 6 as viewed from above on the upper side 61. The guiding ramp 14 is arranged roughly centrally relative to the longitudinal extension L of the instrument panel 6, and passes over into the upper side 61 of the instrument panel 6, or at least sectionally forms the latter, e.g., in an area of the upper side 61 arranged in back of the opening 10 in the traveling direction F.

An end area 20 of the guiding ramp 14 oriented toward the opening 10 exhibits a width that is adjusted to the width B of the opening 10. The guiding ramp 14 is designed as a separate component independent of the second hood section. It is here not joined as a single piece or integrally with the second hood section 15. As viewed from above, the guiding ramp 14 is essentially triangular in shape. It exhibits the trough-like recess 19 that prevents the airbag 9 (FIG. 6) from sagging as it inflates in the direction of the driver 4, and guides it over the steering wheel 7. In addition, its shape is stabilized by the trough-like recess 19.

FIG. 6 shows a side view along the A-A line on FIG. 3 or FIG. 5. The airbag module 8 is integrated into the instrument panel 6 in front of the guiding ramp 14 as viewed in the traveling direction F. The airbag 9 is shown in the inflated state. It has been inflated from the opening 10 in an inflating direction B. The inflating direction B is oriented in the direction of an upper body and head of the driver 4 (FIG. 1).

The guiding ramp 14 is designed as the first hood section 140 for the functional elements 13. The guiding ramp 14 here protrudes as a canopy from the instrument panel 6 at an angle to the direction oriented against the traveling direction F, in particular in the inflating direction B of the airbag 9. The gap Z between the instrument panel 6 and steering wheel is bridged or closed by the guiding ramp 14 by at least 40 percent, preferably by at least 50 percent, specifically by at least 60 percent. In an imaginary extension V of the guiding ramp 14, the latter runs over the steering wheel 7 or past the latter, with the guiding ramp 14 in particular not intersecting the steering wheel 7 in the imaginary extension V. Because the airbag 9 slides over or along the guiding ramp 14 while being inflated, it is guided over the steering wheel 7. The guiding ramp 14 stabilizes and also supports the airbag 9 as it inflates, and points it in the correct direction, so that it can exert its protective effect on the driver 4 fully and unimpeded given a collision of the vehicle 1.

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

1. A vehicle with a driver side and a passenger side, comprising:
an instrument panel is integrated into the vehicle that extends from the driver side to the passenger side in a longitudinal extension,
a steering wheel arranged on the driver side, and protruding from the instrument panel in a direction oriented opposite a traveling direction of the vehicle;
an airbag module with an airbag integrated into the instrument panel in front of the steering wheel as viewed in the traveling direction, wherein the airbag is configured to inflate based at least in part on an opening arranged in the instrument panel in an inflating direction oriented in the direction of an upper body position of the driver; and
a guiding ramp that is configured to guide the airbag at least over the steering wheel upon inflation in the inflating direction.

2. The vehicle according to claim 1, wherein the guiding ramp at least partially bridges a gap between the instrument panel and the steering wheel in the direction oriented opposite the traveling direction.

3. The vehicle according to claim 1, wherein the guiding ramp runs past the steering wheel in the inflating direction of the airbag and in an imaginary extension of the guiding ramp.

4. The vehicle according to claim 1, wherein the guiding ramp protrudes from the instrument panel and adjusted substantially parallel to the inflating direction of the airbag.

5. The vehicle according to claim 1, wherein the guiding ramp is arranged between the opening in the instrument panel and the steering wheel in the longitudinal extension of the instrument panel.

6. The vehicle according to claim 1, wherein the guiding ramp in an end region of the guiding ramp oriented toward the opening comprises a width in the longitudinal extension of the instrument panel that corresponds to a width of the opening.

7. The vehicle according to claim 1, wherein the guiding ramp is arranged centrally to the longitudinal extension of the instrument panel between the driver side and the passenger side.

8. The vehicle according to claim 1, characterized in
wherein that the airbag module is arranged centrally between the driver side and the passenger side in the longitudinal extension of the instrument panel, and
wherein the airbag is a central airbag for substantially simultaneously protecting an upper body and a head of the driver and the passenger.

9. The vehicle according to claim 1, wherein the guiding ramp forms a first hood section for functional elements of the vehicle that are integrated into the instrument panel between the driver side and the passenger side.

10. The vehicle according to claim 1, wherein the guiding ramp passes over to an upper side of the instrument panel panel oriented toward the a windshield of the vehicle.

11. The vehicle according to claim 1, wherein a cross section of the guiding ramp perpendicular to the inflating direction of the airbag comprises a trough-like recess that is configured to stabilize and directionally guide the airbag.

12. The vehicle according to claim 9,
wherein the instrument panel encompasses a second hood section for instrument displays arranged on the driver side and in the instrument panel in front of the steering wheel as viewed in the traveling direction, and
wherein the first hood section and the second hood section are joined as a single piece, formed of a single material, and form a common hood.

13. The vehicle according to claim 12, wherein the common hood extends from the driver side up to at least a center of the instrument panel.

14. The vehicle according to claim 12, wherein the common hood extends over at least approximately 35% of the longitudinal extension of the instrument panel.

15. The vehicle according to claim 12,
wherein the common hood extends at least partially along the longitudinal extension of the instrument panel in a wavelike fashion, and
wherein at least one wave section of the common hood forms the guiding ramp.

16. The vehicle according to claim 12, wherein the common hood extends over at least approximately at least 45% of the longitudinal extension of the instrument panel.

17. The vehicle according to claim 12, wherein the common hood extends over at least approximately 55% of the longitudinal extension of the instrument panel.
